(19) United States
(12) Patent Application Publication
(10) Pub. No.: US 2005/0099285 A1
(43) Pub. Date: May 12, 2005

(54) Transportation-vehicle "Babyminder"

(76) Inventors: Janet Gail Prevatt, Houston, TX (US); Chas Wayne Gray, Houston, TX (US)

Correspondence Address: Janet Gail Prevatt, 4414 Way Cross, Houston, TX, 77035, US

(21) Appl. No.: 10/705,796

(22) Filed: Nov. 12, 2003

(51) Int. Cl. B60Q 1/00

(52) U.S. Cl. 340/457; 340/573.4

(57) ABSTRACT

A transportation-vehicle “babyminder” reminds drivers that babies and/or small children are still in the backseats of their vehicles. This is similar to current front seatbelt alarms in design except that instead a warning device when seatbelts are NOT fastened, a reminder of sound/light occurs when the back seatbelts are left locked. There is more than one way this could be designed. It could use the same warning circuitry as the headlights when they are left on after the ignition is turned off. Another way would be to use the vehicle's alarm system.

### CROSS-REFERENCE TO RELATED APPLICATIONS

None

### FEDERALLY SPONSORED RESEARCH OR DEVELOPMENT

None

### REFERENCE TO SEQUENCE LISTING, A TABLE, OR A COMPUTER PROGRAM LISTING COMPACT DISC APPENDIX

None

### BACKGROUND OF THE INVENTION

In the summer of 2002 (although we are sure this problem occurred earlier and in the winter season) babies and small children died needlessly (and horrifically) in transportation vehicles simply because the adult driver forgot they were in the back seat/s. It is very easy to do. The motion of the vehicle lulls babies and small children to sleep and there is no reminder that they are there.

### BRIEF SUMMARY OF THE INVENTION

This invention will remind drivers that babies and small children are still in the back seat/s of the vehicle and, through a warning device, prevent such life-threatening events from occurring.

### BRIEF DESCRIPTION OF THE SEVERAL VIEWS OF THE DRAWING

None

### DETAILED DESCRIPTION OF THE INVENTION

This device is similar to current front-seat seatbelt alarm in design except that instead of a dash warning light and sound when you don't fasten your belt, a warning sound will occur when the backseat/s belts are locked and the driver's door is opened for exit (once the ignition key is turned off). This sound reminds the driver that there are occupants in the backseat/s of the transportation vehicle. If the driver does not need this alarm, there is no problem since the seatbelts remain unfastened.

There is more than one way to devise this “Babyminder” alarm/warning system.

This device could use the same warning circuitry as the headlights that are left on after the vehicle is turned off. This circuitry includes a buzzer and lines for power. The “Baby-Minder's” buzzer will alert the driver when the ignition is turned off and the backseat belts remain fastened.

The “Baby-Minder” device could also be connected to the vehicle alarm system. The alarm will sound if the backseat seatbelts are connected and the vehicle has been turned off. With a timer device, the sound could be programmed go off after a few seconds.

Note: The vehicle manufacturer can add a dashboard warning light as well to alert the driver.

We claim our invention of the “Babyminder” is a response to babies and small children being forgotten in transportation-vehicles and is entirely the thought and design of the said inventors, Janet Gail Prevatt and Chas Wayne Gray.

1. Connecting the transportation-vehicle's light and/or sound circuitry systems to backseat/s seatbelts, drivers are reminded that babies and/or children still remain in the transportation-vehicle.

2. Using the vehicles' headlight system (claim #1), a dash light would alert the driver that passengers are still in the vehicle.

3. For the hearing-impaired person, adding a blinking overhead light for ten seconds would serve as an additional warning (claim #1) that the backseat/s' seatbelts remain fastened and a baby or child may still be in the vehicle.

3. Using the vehicle's alarm system (claim #1), a warning sound would activate if any backseat/s seatbelts are connected once the ignition is turned off.

4. Opening the driver's door (claim #1) would activate a short baby-on-board reminder sound.
